(19) United States
(12) Patent Application Publication
(10) Pub. No.: US 2013/0188003 A1
(43) Pub. Date: Jul. 25, 2013

(54) Doped Oxide powders in laser markings and methods of use

(71) Applicant: Jagdip Thaker, Schaumburg, IL (US)

(72) Inventor: Jagdip Thaker, Schaumburg, IL (US)

(21) Appl. No.: 13/694,946

(22) Filed: Jan. 22, 2013

Related U.S. Application Data
(60) Provisional application No. 61/632,354, filed on Jan. 23, 2012.

(51) Int. Cl. C08K 3/22

(52) U.S. Cl. CPC C08K 3/22
USPC 347/224; 524/408; 524/413; 524/406; 524/420

(57) ABSTRACT

Laser marking additives of at least one the core particle selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof, and a coating covering at least part of the core particle comprising at least one oxide of a metal selected from the group consisting of Si, Ti, Ce, Zr, Zn, Al, Ba, Sr, La, Mg, Ca, V, Ta and mixtures thereof. This powder is used with 1064 nm wavelength laser (semiconductor lasers, fiber lasers) to change color in a plastic or polymer substrate to give contrast in laser marking plastics.

### CROSS REFERENCE TO RELATED APPLICATIONS

This application claims the benefit of U.S. Provisional Application Ser. No. 61/632,354, filed on Jan. 23, 2012, herein incorporated by reference.

### FIELD OF THE INVENTION

This invention relates to black, white and colored laser marking additives and laser marked plastics with one or more internal additives, utilized in master batches.

### BACKGROUND OF THE INVENTION

Traditional techniques to marks surfaces, such as printing, stamping and labeling, face serious drawbacks such as non-permanence of the mark, which can sometimes be peeled off (in the case of adhesive labeling), scratched off (in the case of stamping), as well as bleeding, non-conforminity of marks (when used in an industrial process), varying quality, etc. Utilizing lasers in marking, in rapid and flexible marking, is of growing importance. Compared to traditional printing techniques such as printing, embossing, stamping, etc., laser marking is much quicker and more precise, in addition to being contactless, which is an added benefit.

Laser marking is a known for quickly marking substrate surfaces with identification marks, such as date codes, batch codes, bar codes, sku numbers, or part numbers, functional design marks, such as computer keyboard characters, and decorative marks, such as pictures and company logos, among many others. The most common laser marks are either a dark mark on a lighter colored background or a light mark on a dark colored background.

The most common mechanism of laser marking of thermoplastic materials depends on the rapid production of heat in the irradiated portion of the plastic due to the absorption of the laser energy. Although some thermoplastics, such as polyethylene, polypropylene and polystyrene, are transparent to laser energy at certain wavelengths, they may be marked by including in the resin composition a laser energy-absorbing additive, such as carbon black. Other polymers, such as polyvinylchloride, polyethylene terephthalate and acrylonitrile butadiene styrene (ABS) absorb laser energy and require little or no special additives.

Plastics are typically laser marked by changing the color of the plastic or foaming the surface of the plastic along the travel path of the laser. Such a process is disclosed in U.S. Pat. No. 5,061,341 to Kildal et al.

Laser marking additives render polymers laser markable by acting as a light absorber for the laser light. Materials that act in this capacity often absorb visible light as well, which imparts a color to the piece to be marked. The color can be in contrast to the desired color of the piece, or it may dilute the desired color. The additive may also reduce clarity of a transparent piece. An appearance change can also be due to scattering of light by the additive. This can happen whether the additive has color or not. As a result, laser marking additives must be used in low concentrations, and/or not used in transparent applications.

### SUMMARY OF THE INVENTION

The present invention relates to laser marking additives and, in particular, laser marking additive particles, and their use in laser marking applications. In one aspect, the laser marking additive described herein is a calcined powder of mixed oxides of zinc, copper, tungsten, titanium, vanadium, molybdenum or any combination thereof, or a solvent or aqueous dispersion, which can be incorporated into compositions to be laser marked. When the laser additive powder absorbs laser energy and converts it into heat, it is believed that carbonization of the surrounding material occurs and results in the formation of a mark (in one embodiment, a black or dark mark) that contrasts with the remainder of the surrounding area.

Upon irradiation with laser light, compositions that contain the laser additive described herein (also sometimes referred to as “laser-markable substrate”) are capable of producing an unexpectedly high contrast between the irradiated and non-irradiated areas.

In one aspect, described herein are laser marking additives comprising a composition of at least one core particle and at least one coating covering the particle. The additive is incorporated into a polymer or plastic prior to laser marking of the polymer or plastic. In one embodiment, the coating comprise one or more oxides of a metal selected from the group consisting of Si, Ti, Ce, Zr, Al, Ba, Sr, La, Mg, Ca, V, Ta and mixtures thereof. In one particular embodiment, the coating comprises one or more layers of a metal oxide. In another embodiment, the coating comprises titanium dioxide or zinc oxide.

The core particle can be selected from copper oxide, chromium oxide, ceramic yellow, cobalt oxide, tungsten oxide, vanadium oxide, titanium oxide, ceramic red, molybdenum oxide, zinc sulfide and any combination thereof.

In another aspect, described herein are methods of making a laser marking additive, said method comprising forming a dispersion of at least one core particle with at least one coating covering the particle.

In yet another aspect, described herein are laser markable substrates comprising: a) a polymer; and b) a laser marking additive comprising at least one core particle and at least one coating; wherein the coating is an oxide of a metal selected from the group consisting of Si, Ti, Ce, Zr, Al, Ba, Sr, La, Mg, Ca, V, Ta and mixtures thereof; and wherein the core particle is selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof. The additive can be incorporated into the polymer prior to laser marking of the polymer.

In another aspect, described herein are laser markable substrates comprising: a) a plastic or polymer; and b) a laser marking additive comprising a composition of at least one core particle and at least one coating covering a part of the core particle, wherein the core particle is selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof, and wherein the coating comprises at least one oxide of a metal selected from the group consisting of Si, Ti, Ce, Zr, Zn, Al, Ba, Sr, La, Mg, Ca, V, Ta and mixtures thereof. The additive can be incorporated into the polymer prior to laser marking of the polymer.

In one embodiment, the core particle is selected from copper oxide, chromium oxide, ceramic yellow, cobalt oxide, tungsten oxide, vanadium oxide, titanium oxide, ceramic red, molybdenum oxide, zinc sulfide or any combination thereof.

In one embodiment, and wherein the coating (covering a part of the core particle) comprises at least one oxide of a metal selected from Si, Ti, Ce, Zr, Zn, Al, Ba, Sr, La, Mg, Ca, V, Ta or mixtures thereof.

In one embodiment, the core particle and coating is selected from copper oxide, zinc sulfide or any combination thereof. In another embodiment, the core particle is selected from copper oxide, zinc sulfide, ceramic yellow, cobalt oxide, ceramic red or any combination thereof. In yet another embodiment, the coating comprises at least one oxide of a metal selected from Ti, Zn or mixtures thereof, typically Ti.

In one embodiment, the laser marking additive comprises, by weight of additive: a) greater than about 50 wt % zinc oxide; b) from about 0.5 wt % to about 25 wt % copper oxide; and c) at least one component of: (i) from about 1 wt % to about 40 wt % tungsten oxide, (ii) from about 1 wt % to about 40 wt % vanadium oxide, and (iii) from about 1 wt % to about 25 wt % molybdenum oxide.

In another embodiment, the laser marking additive comprises, by weight of additive: a) greater than about 50 wt % zinc oxide or titanium dioxide; b) from about 0.5 wt % to about 25 wt % copper oxide; and c) at least one component of: (i) from about 0.1 wt % to about 40 wt % tungsten oxide, (ii) from about 0.1 wt % to about 40 wt % vanadium oxide, and (iii) from about 0.1 wt % to about 25 wt % molybdenum oxide.

In another aspect, described herein are methods for producing a laser markable plastic or polymer comprising incorporating into the plastic or polymer at least one laser marking additive comprising: at least one core particle, and at least one coating covering a part of the core particle. The core particle can be selected from copper oxide, chromium oxide, ceramic yellow, cobalt oxide, tungsten oxide, vanadium oxide, titanium oxide, ceramic red, molybdenum oxide, zinc sulfide or any combination thereof. The coating can comprise at least one oxide of a metal selected from Si, Ti, Ce, Zr, Zn, Al, Ba, Sr, La, Mg, Ca, V, Ta or mixtures thereof. The additive can be incorporated into a polymer prior to laser marking of the polymer. The method further comprises the step of irradiating a portion of the substrate with a laser beam to form a marking thereon.

In yet another aspect, described herein are one or more masterbatches, wherein the masterbatch comprises: a polymer or plastic; and a laser marking additive comprising a composition of at least one core particle and at least one coating covering a part of the core particle, wherein the core particle is selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof, and wherein the coating comprises at least one oxide of a metal selected from the group consisting of Si, Ti, Ce, Zr, Zn, Al, Ba, Sr, La, Mg, Ca, V, Ta and mixtures thereof. The masterbatch is incorporated into a plastic substrate prior to laser marking of the plastic substrate. In one embodiment, the masterbatch comprises a plastic comprising polyethylene, polypropylene, polyamide, polyurethane, polyesters, thermoplastic vulcanisates, polyolefin, polybutadiene, (meth)acrylic polymers, polyethyl acrylate, polymethyl methacrylate; polyesters, polyethylene terephthalate, polybutylene terephthalate; polyvinyl chloride; polyvinylidene chloride; polyacrylonitrile; epoxy resins and any combinations thereof.

In one specific embodiment, the masterbatch comprises, by weight of total masterbatch: from about 0.1 wt % to about 5 wt % of the laser marking additive; and from about 4 wt % to about 99.9 wt % of the polymer or plastic. It is understood that the plastic substrate can be any three dimensional structure that is desired as the end product, e.g., a curved three dimensional structure.

In yet another aspect, described herein are methods of marking a surface of a laser-markable substrate comprising irradiating a portion of the substrate with a laser beam to form a marking thereon, wherein the laser-markable substrate comprises at least one laser marking additive particle comprising a core particle and a coating covering the particle, wherein the coating is an oxide of a metal selected from the group consisting of Si, Ti, Ce, Zr, Al, Ba, Sr, La, Mg, Ca, V, Ta and mixtures thereof, and wherein the core particle is selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof.

In an alternative aspect, described herein are laser marking additive wherein the laser marking additive comprises, by weight of additive: a) greater than about 50 wt % zinc oxide; b) from about 0.5 wt % to about 25 wt % copper oxide; and c) at least one component of: (i) from about 1 wt % to about 40 wt % tungsten oxide, (ii) from about 1 wt % to about 40 wt % vanadium oxide, and (iii) from about 1 wt % to about 25 wt % molybdenum oxide.

### DESCRIPTION OF THE INVENTION

Described herein are laser marking additives capable of being utilized in conjunction with a laser. The laser marking additive is introduced or added into a composition, such as a polymeric composition or composition containing in-part a polymer, in such a content that the composition contains at least 0.1 wt. % of the laser marking additive so as to be able to apply a dark or colored marking against a light background in the composition. In one embodiment, the composition contains at least 0.5 wt. % of the laser marking additive so as to be able to apply a dark marking against a light background in the composition. In another embodiment, the composition contains at least 1 wt. % of the laser marking additive so as to be able to apply a dark marking against a light background in the composition. In yet another embodiment, the composition contains at least 2 wt. % or at least 3 wt % or at least 4 wt % or at least 5 wt % of the laser marking additive so as to be able to apply a dark marking against a light background in the composition or laser markable substrate. In some embodiments, the contrasting marking or irradiated portion of the laser-markable substrate is a different color than the non-irradiated portion of the laser-markable substrate. For example, the irradiated portion can be red color or of a red-hue while the non-irradiated portion is white. As another example, the irradiated portion can be a blue color or of a blue-hue while the non-irradiated portion is white. In yet another example, the irradiated portion can be green while the non-irradiated portion is red.

In one embodiment, the laser utilized in connection with the laser marking additives described herein is a YAG laser (such as, ND:YAG of 1064 nm wavelength). It is understood, however, that suitable laser or similar irradiating device can be used. In another embodiment, the laser has a wavelength in the near infrared (780 nm to 2000 nm), which can include, by way of example, solid state pulsed lasers and continuous wave lasers with pulse modification, such as frequency-doubled Nd:YAG laser (wavelength 532 nm), and diode laser at about wavelength 1064 nm. In some embodiments, the laser is an Nd:YAG laser (wavelength 1064 nm) or a diode laser (at about wavelength 1064 nm). In other embodiments, the laser is a single mode YAG laser (wavelength 1064 nm).

In one embodiment, the additive is a powder of mixed oxides of zinc or copper and one or more doping agents. In one embodiment, the doping agent is one or any mixture of the following: copper, tungsten, vanadium, molybdenum, titanium. In another embodiment, the laser additive is a zinc oxide with only small or trace amounts of doping agent. Typically, the zinc oxide or other metal oxide is present in amounts greater than about 50 wt %, of total additive weight. In other embodiments, zinc oxide or other metal oxide is present in amounts greater than about 50 wt %, of total laser additive dry weight. In further embodiments, zinc oxide or other metal oxide is present in an amount greater than about 60 wt %, of total additive weight. In one additional embodiment, zinc oxide or other metal oxide is present in an amount greater than about 70 wt %. In yet another embodiment, zinc oxide or other metal oxide is present in an amount greater than about 75 wt %. In yet another embodiment, zinc oxide or other metal oxide is present in an amount greater than about 80 wt % (of total additive weight).

In one embodiment, the doping agent is copper oxide present in an amount from about 0.1 wt % to about 50 wt % by total additive weight, typically from about 0.5 wt % to about 25 wt %. In other embodiments, when the doping agent is copper oxide, the copper oxide is present in an amount from about 4 wt % to about 10 wt % (by total additive weight). It is understood that copper oxide can be used in addition to the other compounds listed under doping agents, and vice versa. In some embodiments, when present, the level of tungsten oxide is from between from about 0.1 wt % to about 50 wt % of total weight of additive, typically, from about 0.5 wt % to about 30 wt %. In some embodiments, when present, the level of vanadium oxide is from between from about 0.1 wt % to about 50 wt % of total weight of additive, typically, from about 0.5 wt % to about 30 wt %. In other embodiments, when present, the level of molybdenum oxide is from between from about 0.1 wt % to about 35 wt % of total weight of additive, typically, from about 0.5 wt % to about 25 wt %. In one embodiment, copper oxide is mixed with vanadium oxide, molybdenum oxide, or tungsten oxide to form the doping agent.

In other embodiments, when present as or as part of the doping agent, the level of zinc sulfide is from between from about 0.1 wt % to about 30 wt % of total weight of additive, typically, from about 1 wt % to about 25 wt %. In other embodiments, when present as or as part of the doping agent, the level of titanium oxide is from between from about 0.01 wt % to about 10 wt % of total weight of additive, typically, from about 0.1 wt % to about 4 wt %.

In another embodiment, the laser marking additive is a powder of mixed oxides of zinc, copper, tungsten, vanadium, molybdenum, titanium. The components can be mixed in any desired amounts. For example, the powder can be a mixture of from 25-50 wt % (of dry mixture) zinc oxide and from 25-50 wt % copper oxide. In another non-limiting example, the powder can be a mixture of from 20-80 wt % copper oxide and from 20-50 wt % of titanium oxide.

In one embodiment, the laser marking additive particle comprises at least one core particle and a coating covering at least a part of the particle, wherein the coating is an oxide of a metal selected from the group consisting of Si, Ti, Ce, Zr, Al, Ba, Sr, La, Mg, Ca, V, Ta and mixtures thereof, and wherein the core particle is selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof.

In one embodiment, the coating is a titanium compound such as titanium dioxide. Other titanium compounds however include, but are not limited to such compounds as the following: Tetraisopropyl titanate, Tetra-n-butyl titanate, Tetrakis(2-ethylhexyl)titanate, Lactic acid titanium chelate, Titanium acetylacetonate, Triethanolamine titanium chelate, Titanium ethyl acetoacetonate chelate, or a combination thereof.

The laser marking additive described herein may be prepared by any suitable method known to one skilled in the art. In some embodiments, zinc oxide and doping agent are combined and mixed thoroughly using a waring blender or appropriate mixing device for large scale production to prepare the laser marking additive. It is understood that the laser marking additive can contain additional components such as thickeners, binders, stabilizers, dispersing agents, surfactants, anti-foaming agents, corrosion inhibitors, and the like. The laser marking additive is then calcined/heated to an appropriate temperature. In one embodiment, the laser marking additive is heated to at least about 750° C. In other embodiments, the laser marking additive is heated to at least about 1000° C. The heating/calcination period is generally less than 5 hours, typically less than 4 hours, in other embodiments, less than 2 hours. In some embodiment, the heating/calcination period is less than 1 hour, typically, less than 45 minutes. It is understood, however, that these periods may be adjusted along with varying temperatures. In some embodiments, calcination may be performed at higher temperatures and/or for longer periods of time than that specifically disclosed above.

In some embodiments, the resulting material is generally in particulate-form but can thereafter be ground or milled to a desired size. In some embodiments, the average particle size or average particle diameter (D₅₀) is less than about 10 micrometer (μm), measured by light scattering or any other means generally available to one skilled in the art. In some other embodiments, the average particle diameter is less than 5 micrometer (μm), which in another embodiment is less than 1 micrometer (μm).

In yet other embodiments, the average particle diameter is in the range of from about 1 nanometer (nm) to about 10 micrometer (μm), and in other embodiments, from about 10 nm to about 7 μm. In some embodiments, the particles have an average particle diameter in the range of from about 50 nm to about 1 μm. Various and known methods are available for forming the laser marking additives into nano-sized particles (less than about 100 nm). In other embodiments, particles having an average particle diameter of less than about 100 nm are utilized. In some embodiments, the average particle size is from about 25 nm to about 50 nm. Any suitable method for making the particles may be employed including mechanical processing, chemical processing, or physical (thermal) processing. Generally, in mechanical processes, powders are made from large particles using crushing techniques such as a high-speed ball mill. Generally, with chemical processes, materials are created from a reaction that precipitates particles of varying sizes and shapes using a family of materials known as organometallics (substances containing combinations of carbon and metals bonded together) or various metal salts. The chemical processes are often combined with thermal processing, e.g. pyrolysis.

The compounds may be added as an individual component during blending, for example, dry blending of the components prior to prior to processing, or the compound may be added as a blend, masterbatch, flush, or other concentrate in or with another substance prior to processing. Typically, the other substance is the polymer or plastic. The compounds may be added during processing steps. Standard process steps for are well known in the art and include extrusion, coextrusion, blow molding, compression molding, Brabender melt processing, injection molding, film formation, other molding and sheet forming processes, fiber formation, surface impregnation, dissolution, suspension, dispersion and other methods known in plastic and coatings technology.

In one embodiment, the additives described herein can be added to the plastic or polymer substrate directly. In another embodiment, however, the additives described herein can be added in the form of a concentrate or masterbatch (hereinafter collectively referred to as “masterbatches” or “masterbatch”), which masterbatch is added directly to the plastic or polymer. It is believed that masterbatches facilitate substantially even and/or homogenous mixing or incorporation of the additive into the plastic or polymer substrate.

In one embodiment, the masterbatch comprises one or more additives described herein and at least one dispersion carrier. Generally, masterbatch is already very similar to that of the laser-markable plastic, but the individual components are present in a more concentrated form (e.g., additives). The masterbatch may comprise further components such as, for example, dispersion aids, color pigments, dyes and the like. In one embodiment, the dispersion carrier may comprise at least one plastic component, in addition to other components (e.g., resins). Typically, at least one plastic component of the dispersion carrier is a polymer compatible with the plastics material into which it is incorporated. In one embodiment, the plastic component incorporated as part of the masterbatch is identical with the polymer or plastic substrate into which the laser marking additive is to be finally incorporated.

Typically, a masterbatch is produced in a suitable mixer, for example a tumbler mixer. In one embodiment, one or more additives described herein is combined with plastic pellets, or any plastic starting material, and typically heated to a suitable temperature. The combined formulation is then extruded and further processed to form masterbatch pellets. The masterbatch can also be produced by incorporating the additive(s), and where appropriate further components, directly into the plastic during the course of the extrusion process. The masterbatch, in one embodiment, comprises at least the additive described herein and the plastic component, which is in an efficient form for ease of use and transport. This efficient form can, in one embodiment, comprise pellets, chips, granules, briquettes and/or the like. The additive present in the masterbatch is in an amount from 0.001% to 15% by weight, or in another embodiment, from 0.01% to 10% by weight, or in yet another embodiment, from 0.1% to 6% by weight, based on the total weight of the masterbatch.

In one embodiment, only a small amount of the laser marking additive needs to be added to the final material to be marked such as a plastic or polymer substrate. Typically, the loading level of the laser marking additive is from about 0.001% to about 20% of the total weight of the substrate or material to be marked. In some embodiments, the laser marking additive loading is from about 0.01% to about 10%. In further embodiments, the laser marking additive loading is from about 0.01% to about 5%. In other embodiments, the marking additive loading is about 0.05% to about 1%. The laser marking additive can be incorporated into any plastic material which is transparent to YAG laser irradiation. Accordingly, the invention further provides a method of preparing a laser markable plastic and a method of preparing a laser marked article.

In some cases, the substrate or material to be marked comprises a plastic or polymer. Examples of polymers include but are not limited to polyethylene, polypropylene, polyamide, polyurethane, polyesters, and/or thermoplastic vulcanisates. In other embodiments, the material or polymer (i.e., material to be marked) include, but are not limited to, polyolefins, polypropylene, polybutadiene and the like; (meth)acrylic polymers such as polyethyl acrylate and polymethyl methacrylate and the like; polyesters such as polyethylene terephthalate and polybutylene terephthalate and the like; polyvinyl chloride; polyvinylidene chloride; polyacrylonitrile; epoxy resins; and polyurethanes. The polymer can also be a copolymer or block copolymer, etc.

Other examples of polymers or plastics comprising all or part of the substrate include but are not limited to: thermoplastics of polyoxyalkylenes, polycarbonates, polyesters such as polybutylene terephthalate (PBT) or polyethylene terephthalate, vinylaromatic (co)polymers such as polystyrene, impact-modified polystyrene such as HI-PS, or ASA, ABS or AES polymers, polyolefins such as polyethylene or polypropylene, poly(meth)acrylates, polyamides, polyarylene ethers such as polyphenylene ethers (PPE) polysulfones, polyurethanes, polylactides, halogen-containing polymers, polymers containing imide groups, cellulose esters, silicone polymers, and thermoplastic elastomers. In another embodiment, polyethylene terephthalate (PET), polyethylene naphthalate, and/or polybutylene terephthalate can be utilized. Mixtures of different thermoplastics can also be used. Among the poly(meth)acrylates, mention can be made of polymethyl methacrylate and also copolymers based on methyl methacrylate such as n-butyl acrylate, tert-butyl acrylate or 2-ethylhexyl acrylate.

### EXPERIMENTS

### Experiment 1

The following batches were mixed in the blender and sintered in Nitrogen atmosphere at 700 deg C. to 1200 deg C. to give the laser marking additive in the form of agglomerates. These agglomerates were ground to get a fine powder with average particle size of 3 to 4 microns. The powders are given in wt % by total weight of powder.
Powder 1.: Zinc Oxide (70%), Copper Oxide (0.5%), Tungsten Oxide (29.5%)
Powder 2.: Zinc Oxide (70%), Copper Oxide (4.5%), Vanadium Oxide (25.5%)
Powder 3.: Zinc Oxide (75%), Copper Oxide (10.5%), Molybdenum Oxide (19.5%)
Powder 4.: Zinc Oxide (78%), Zinc Sulfide (22%)
Powder 5.: Zinc Oxide (88%), Zinc Sulfide (11.5%), Titanium Oxide (0.5%)

The five master batches were made with each of the above powder compositions, respectively, with polyethylene and polystyrene polymers as the plastic component, which masterbatch comprises about 4% powder and about 90% polymer. Small amounts of additional additives were incorporated such as foaming agents and the like. A few plastic chips were molded to laser mark with 1064 nm laser.

The results were compared with different settings under a CO2 laser and the batches were observed have a distinct contrast of black markings (irradiated portions) in the first three powders versus non-irradiated portions.

In Powders 4 and 5, SAFOAM foaming agents (about 2 wt %) were added and the masterbatches were molded as dark colored plastic chips to be laser marked by settings of 1064 laser.

Both these powders (Powder 4 and Powder 5) show light colored laser marks as a result of laser marking, against the dark background of the plastic chip.

### Experiment 2

In a second experiment, the following batches were mixed in the blender and sintered in under nitrogen atmosphere at about 700 degrees C. to 1200 degrees C. to give the doped compound. These agglomerates were ground to get fine powder with average particle size of 3 to 4 microns.

The basic requirements are to get light colored powders, dark colored powders to be used in plastics master batches and the color is the result of laser marking with 1064 nm wavelength lasers.

Powder 1.: Copper Oxide (80%), Titanium dioxide (20%)—coated color whitish, laser black

Powder 2.: Titanium dioxide (25%), Chromium green Oxide (75%)—coated color whitish, laser green

Powder 3.: Ceramic Yellow (75%), Titanium dioxide (25%)—coated color whitish, laser yellow

Powder 4.: Cobalt Oxide (75%), Titanium dioxide (25%)—coated color whitish, laser blue

Powder 5.: Ceramic Red (75%), Titanium Oxide (25%)—coated color whitish, laser red

The five master batches were made with each of the above powder compositions, respectively, with polyethylene and polystyrene polymers as the plastic component, which masterbatch comprises about 4% powder and about 90% polymer. Small amounts of additional additives were incorporated such as foaming agents and the like. A few plastic chips were molded to laser mark with 1064 nm laser.

The same can also be applied in marking pharmaceutical drugs and the like. The FDA approved colors and oxides give different colors.

The results were compared with different settings and were observed to be good contrast of COLORS, whites & blacks in the laser marks. Into the formulation were added SAFOAM foaming agents (approx 2 wt %) and were molded as dark colored plastic chips to be laser marked by foaming with 1064 laser.

These powders can be converted in to pastes, paints, inks, tapes, aerosols, to give the same quality of colored laser markings.

While the invention has been depicted and described and is defined by reference to particular specific embodiments of the invention, such references do not imply a limitation on the invention, and no such limitation in scope is to be inferred.

What is claimed is:

1. A laser marking additive comprising a composition of at least one core particle and at least one coating covering a part of the core particle,
wherein the core particle is selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof, and
wherein the coating comprises at least one oxide of a metal selected from the group consisting of Si, Ti, Ce, Zr, Zn, Al, Ba, Sr, La, Mg, Ca, V, Ta and mixtures thereof,
whereby the additive is incorporated into a polymer prior to laser marking of the polymer.

2. The laser marking additive of claim 1 wherein the core particle is selected from the group consisting of copper oxide, zinc sulfide and any combination thereof.

3. The laser marking additive of claim 1 wherein the core particle is selected from the group consisting of copper oxide, zinc sulfide, ceramic yellow, cobalt oxide, ceramic red and any combination thereof.

4. The laser marking additive of claim 1 wherein the coating comprises at least one oxide of a metal selected from the group consisting of Ti, Zn and mixtures thereof.

5. The laser marking additive of claim 1 wherein the coating comprises at least one oxide of Ti.

6. A method for producing a laser markable plastic or polymer comprising incorporating into the plastic or polymer at least one laser marking additive comprising:
at least one core particle, and
at least one coating covering a part of the core particle,
wherein the core particle is selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof, and
wherein the coating comprises at least one oxide of a metal selected from the group consisting of Si, Ti, Ce, Zr, Zn, Al, Ba, Sr, La, Mg, Ca, V, Ta and mixtures thereof,
whereby the additive is incorporated into a polymer prior to laser marking of the polymer.

7. The method of claim 6 wherein the core particle is selected from the group consisting of copper oxide, zinc sulfide and any combination thereof.

8. The method of claim 6 wherein the core particle is selected from the group consisting of copper oxide, zinc sulfide, ceramic yellow, cobalt oxide, ceramic red and any combination thereof.

9. The method of claim 6 wherein the coating comprises at least one oxide of a metal selected from the group consisting of Ti, Zn and mixtures thereof.

10. The method of claim 6 wherein the coating comprises at least one oxide of Ti.

11. The method of claim 6 further comprising the step of irradiating a portion of the substrate with a laser beam to form a marking thereon.

12. The laser marking additive of claim 1 wherein the laser marking additive comprises, by weight of additive:
a) greater than about 50 wt % zinc oxide;
b) from about 0.5 wt % to about 25 wt % copper oxide; and
c) at least one component of:
(i) from about 1 wt % to about 40 wt % tungsten oxide,
(ii) from about 1 wt % to about 40 wt % vanadium oxide, and
(iii) from about 1 wt % to about 25 wt % molybdenum oxide.

13. The laser marking additive of claim 1 wherein the laser marking additive comprises, by weight of additive:
a) greater than about 50 wt % zinc oxide or titanium dioxide;
b) from about 0.5 wt % to about 25 wt % copper oxide; and
c) at least one component of:
(i) from about 0.1 wt % to about 40 wt % tungsten oxide,
(ii) from about 0.1 wt % to about 40 wt % vanadium oxide, and
(iii) from about 0.1 wt % to about 25 wt % molybdenum oxide.

14. A masterbatch wherein the masterbatch comprises:
a polymer or plastic; and
a laser marking additive comprising a composition of at least one core particle and at least one coating covering a part of the core particle, wherein the core particle is selected from the group consisting of copper oxide, chromium oxide, ceramic yellow, cobalt oxide, tungsten oxide, vanadium oxide, titanium oxide, ceramic red, molybdenum oxide, zinc sulfide and any combination thereof, and wherein the coating comprises at least one oxide of a metal selected from the group consisting of Si, Ti, Ce, Zr, Zn, Al, Ba, Sr, La, Mg, Ca, V, Ta and mixtures thereof,
whereby the masterbatch is incorporated into a plastic substrate prior to laser marking of the plastic substrate.

15. The masterbatch of claim 14 wherein the polymer or plastic comprises polyethylene, polypropylene, polyamide, polyurethane, polyesters, thermoplastic vulcanisates, polyolefin, polybutadiene, (meth)acrylic polymers, polyethyl acrylate, polymethyl methacrylate; polyesters, polyethylene terephthalate, polybutylene terephthalate; polyvinyl chloride; polyvinylidene chloride; polyacrylonitrile; epoxy resins and any combinations thereof.

16. The masterbatch of claim 14 wherein the masterbatch comprises, by weight of total masterbatch:
from about 0.1 wt % to about 5 wt % of the laser marking additive; and
from about 4 wt % to about 99.9 wt % of the polymer or plastic.

17. The masterbatch of claim 14 wherein the plastic substrate is a three dimensional structure.
